(19) United States
(12) Patent Application Publication
(10) Pub. No.: US 2024/0415740 A1
(43) Pub. Date: Dec. 19, 2024

(54) NASOGASTRIC TUBE WITH MULTIPLE PASSAGES

(71) Applicant: JOYEUX LAB COMPANY LIMITED, TAIPEI CITY (TW)

(72) Inventors: YI-CHING LIU, TAIPEI CITY (TW); HSIN-HUA TSAI, TAIPEI CITY (TW)

(21) Appl. No.: 18/816,955

(22) Filed: Aug. 27, 2024

Related U.S. Application Data
(63) Continuation-in-part of application No. 16/967,677, filed on Aug. 5, 2020.

(51) Int. Cl. A61J 15/00

(52) U.S. Cl. CPC A61J 15/0003; A61J 15/0073; A61J 15/0084; A61J 2200/72

(57) ABSTRACT

A nasogastric tube is provided, and includes an adapter and an extension in order to construct a first path and a second path that are separated from each other. The extension is constructed as a single tube body with a front end disposed on the adapter, the extension has a first passage and a second passage that are separated from each other. The adapter includes a first connection port and a second connection port respectively connected to the first passage and the second passage. The extension has a first opening connected to the first passage, a portion of the extension where the first opening exists is configured to define a working portion, the working portion is configured to be positioned only in the hypopharynx, and the working portion is ranged from 0.1 cm to 3 cm in an elongated direction of the extension.

### FIELD OF THE INVENTION

The present disclosure relates to medical devices, particularly to a nasogastric tube with multiple passages adapted to connect the cavity form nose to stomach, and the cavity form nose to throat respectively.

### BACKGROUND OF THE INVENTION

Patients with eating or swallowing difficulties generally need a catheter, known as a nasogastric tube, inserted through the nasal cavity, throat and esophagus into the stomach to facilitate input of liquid food or reversely output of the stomach contents for the purpose of relieving stress or medical diagnosis.

Patients with productive cough (i.e. cough with sputum) difficulties generally need a catheter, known as a suction tube, entered through the nasal or oral cavity into the throat and the upper trachea to discharge the sputum by means of negative pressure suction, in order to keep the respiratory tract open.

Patients with hypoxemia need a catheter to deliver high concentration oxygen to the nasal cavity to improve respiratory performance and the oxygen concentration in blood.

Please refer to FIG. 13, anatomically, the throat refers to the front part of the neck and includes two main structures: the pharynx and the larynx. The lower portion of the throat contains the upper openings of both the esophagus and the trachea (windpipe). In this lower region, cartilages 931 surround the trachea 93, serving two functions: they maintain an open airway at the upper opening of the trachea 93 and separate the esophagus 93 from the trachea.

For patients with dysphagia (swallowing difficulties), using a nasogastric tube is necessary for feeding. Additionally, the patient can't cope with large amounts of saliva. When lying down, saliva from the mouth flows downward and backward along the posterior throat wall, accumulating at the esophagus opening, when the patient is lying down. One the other hand, when a nasogastric tube is inserted, it is placed along a path through the nasal cavity 91 and hypopharynx 94. The mucous membranes in these areas, when irritated by the foreign object, produce secretions. These secretions 95 accumulate along the inserted tube on the posterior wall of the throat.

Because the patient cannot swallow liquids into the esophagus, these accumulated fluids need to be removed to prevent overflow into the trachea 93, which could cause infection or pneumonia. Therefore, another one suction tube must be inserted into the throat or even inserted into the upper trachea to remove these fluids.

In other words, when a patient already has a nasogastric tube in place, in some situations, it's still necessary to insert other types of tubes into the body. These tubes may enter through the nose or mouth to perform vital functions such as feeding, mucus removal, and breathing assistance. If patients are conscious, the insertion of multiple tubes simultaneously frequently causes severe discomfort.

### SUMMARY OF THE INVENTION

The first objective of the present disclosure is to provide a nasogastric tube with multiple passages individually being connected to outer tube to establish multiple supply paths, thereby achieving the purpose of feeding or discharging secretions (e.g. sputum, saliva, etc.) from inside the human body.

The second objective of the present disclosure is to provide said nasogastric tube with multiple passages capable of being independently used in the stomach or throat or in both systems simultaneously.

The third objective of the present disclosure is to provide said nasogastric tube having a multi-chamber, the chambers are not fluidly connected with each other, in order to prevent different substances (e.g. liquid, medicinal powder, gas, etc.) among the chambers from interfering with one another.

The fourth objective of the present disclosure is to provide said nasogastric tube with housing being provided with a plurality of external ends (i.e. multiple connection ports) for respectively connecting to the outer tubes and a single internal end (i.e. the extension as mentioned in the present disclosure).

The fifth objective of the present disclosure is to provide said nasogastric tube wherein the external ends and the internal end are capable of exchanging substances unidirectionally or bidirectionally to achieve the purpose of a single multifunctional device.

The sixth objective of the present disclosure is to provide said nasogastric tube wherein the purpose of avoiding misplacement of the outer tubes may be achieved by means of an anti-tube misplacement (or foolproof) mechanism.

The seventh objective of the present disclosure is to provide said nasogastric tube wherein adaptation to various functionalities may be achieved by means of adjusting the dimensions of the chambers.

The eighth objective of the present disclosure is to provide said nasogastric tube having an opening closure member to close the supply path to protect the unused supply paths.

The ninth objective of the present disclosure is to provide said nasogastric tube wherein the disposition thereof on a patient's nose, face, ears, head or clothing may be facilitated by means of a fastener fixing the outer tube.

The tenth objective of the present disclosure is to provide said nasogastric tube in combination with electronic components (e.g. control module, physiological monitoring module, environment monitoring module, etc.) to achieve the purpose of monitoring, calculating and recording.

The eleventh objective of the present disclosure is to provide said nasogastric tube with an indicator. The indication purpose is achieved by modifying one or more characteristics of the connection port, including but not limited to its shape (tube form), size (tube diameter), profile, color, extension direction, or by adding markings (text or patterns) thereto. The indicator is configured to identify connection ports with different functions, indicate supply paths, or to avoid misplacement of the tubes which may damage to a patients' organs or endanger their lives.

The twelfth objective of the present disclosure is to provide said nasogastric tube with a signal outputting module communicating with the monitoring modules. These electric modules are configured to monitor, record, and display the status of related path (chambers or passages).

The thirteenth objective of the present disclosure is to provide said nasogastric tube with an extension having multiple openings. The extension appears as a single tube body, with multiple openings individually connected to different supply paths. The length of the extension may be flexibly set in order to lead the paths being placed near or inside an organ.

The fourteenth objective of the present disclosure is to provide said nasogastric tube wherein the opening of the extension may be disposed nearby an organ in order to achieve the purpose of directly feeding or extracting (or discharging) substances from the lumen of throat or conducting drainage. The openings, which disposed on different positions of the extension, are configured to be applied to different locations, and there may be multiple openings at specific positions.

In order to achieve the aforesaid objectives among others, the present disclosure provides a nasogastric tube with multiple passages, the nasogastric tube comprises an adapter and an extension. The adapter comprises a housing defining a mounting space, a first connection port and a second connection port, the mounting space fluidly connected to the first connection port and the second connection port respectively. The extension is constructed as a single tube body with a front end being disposed on the housing, the extension has a first passage and a second passage that are separated from each other. The extension has a first opening connected to the first passage and has a second opening connected to the second passage, the extension is extended alone an elongated direction, a portion of the extension where the first opening exists is configured to define a working portion and is placed between the front end and the second opening.

The first connection port, one portion of the mounting space, and the first passage in combination are configured to establish a first path. The second connection port, the other portion of the mounting space, and the second passage in combination are configured to establish a second path separated from the first path. The working portion is configured to be positioned only in the hypopharynx, and the working portion is ranged from 0.1 cm to 3 cm in the elongated direction.

The terms “single tube body” refer to a tubular structure that internally contains multiple passages, while externally presenting as a single tube. In other words, the extension (or passage) does not have any branches in directions other than the elongation direction, the whole extension may be inserted into the human body along an elongated direction of one lumen. Under a similar concept, the extension may be formed by connecting the outer surfaces of two tubes together. The extension may also be formed by one tube sleeved on another tube, creating multiple passages within the extension.

The nasogastric tube with multiple passages disclosed in the present disclosure may be connected to a plurality of outer tubes by first connection port and the second connection port. An external equipment may be connected to the nasogastric tube through the plurality of outer tubes in order to serve various functions. The combination structures of the adapter and the extension are configured to define independent paths, the paths are capable of executing designated functions independently without interference. Moreover, the extension correspondingly forms portions of first path and second path. The extension have openings placed respectively nearby organs or inside the tubular organ (e.g. stomach), so as to provide related function (e.g. feeding food, supplying oxygen, conducting drainage, drawing sputum, injecting medicine) by means of connecting to the external equipment and corresponding first path and second path.

The present disclosure is an improvement based on the nasogastric tube structure which appears as a single tube body. When the present disclosure is inserted into the human body, one end (rear end) of the single tube body paths through the nasal cavity, the esophagus then enters into the stomach. When the present disclosure is used for application to the throat, the single tube body itself does not enter the trachea.

When the nasogastric tube of this disclosure is inserted into the human body, the first opening connected to the first path is located between the epiglottis and the opening of the esophagus, approximately at the position of the hypopharynx, which may be constructed as a suction tube.

In addition, the first opening of the working section may be constructed to be positioned only in the hypopharynx and be directed toward the pyriform sinus, the length of the working section along the elongated direction ranges from 1 cm to 1.5 cm. An accurate working section can concentrate the suction action in a specific area, resulting in a more effective suction effect.

### BRIEF DESCRIPTION OF THE DRAWINGS

FIG. 1 is a sectional structure diagram of a first embodiment of the nasogastric tube.

FIG. 2 is a schematic diagram of the first embodiment of the nasogastric tube being connected to an outer tube.

FIG. 3 is a structure diagram of a second embodiment of the nasogastric tube.

FIG. 4 is a structure diagram of a third embodiment of the nasogastric tube.

FIG. 5 is a structure diagram of a fourth embodiment of the nasogastric tube.

FIG. 6 is a structure diagram of a fifth embodiment of the nasogastric tube.

FIG. 7 is a structure diagram of a sixth embodiment of the nasogastric tube.

FIG. 8 is an appearance diagram of a seventh embodiment of the nasogastric tube.

FIG. 9 is a sectional view of the seventh embodiment.

FIG. 10 is an assembled sectional view of the seventh embodiment.

FIG. 11 is a schematic diagram showing the use of the seventh embodiment for suction.

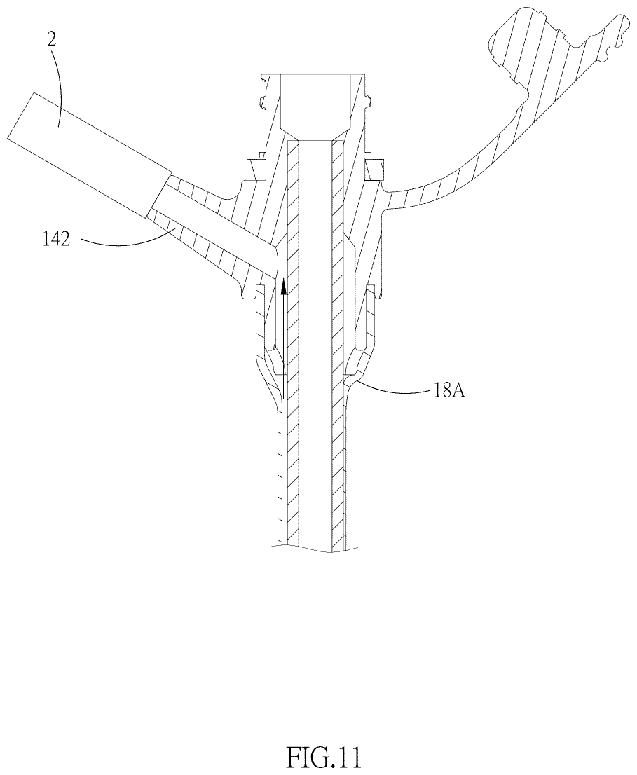

FIG. 12 is a schematic diagram showing the use of the seventh embodiment.

FIG. 13 is an anatomical diagram of the upper respiratory tract.

### DETAILED DESCRIPTION OF THE PREFERRED EMBODIMENTS

In order to fully understand the objectives, features, and functions of the present disclosure, the present disclosure is described in detail as follows by the following specific embodiments along with the accompanying figures.

In the present disclosure, “a” or “one” is used to describe the units, elements, and components described herein. This is done for the convenience of description only and provides a general meaning to the scope of the present disclosure. Therefore, unless stated otherwise, this description should be understood to include one, at least one, and more than one.

In this present disclosure, the terms “comprising”, “including”, “having” or “containing” are intended to encompass non-exclusive inclusions. For example, an element, structure, article, or device that comprises a plurality of elements is not limited to such elements as listed herein, but may include those not specifically listed but which are generally inherent in the element, structure, article, or device. In addition, the term “or” is used to mean an inclusive “or” rather than an exclusive “or” unless expressly stated to the contrary.

In this present disclosure, for ease of understanding, terms “inner tube” and “outer tube” are used to distinguish the tubes in the embodiments, indicating whether they are located inside or outside the human body during use.

There are embodiments as bellow provided a nasogastric tube with multiple passages, the nasogastric tube comprises an adapter and an extension.

The adapter comprises a housing defining a mounting space, a first connection port and a second connection port, the mounting space fluidly connected to the first connection port and the second connection port respectively. The extension is constructed as a single tube body with a front end being disposed on the housing, the extension has a first passage and a second passage that are separated from each other. The extension has a first opening connected to the first passage and has a second opening connected to the second passage, the extension is extended alone an elongated direction, a portion of the extension where the first opening exists is configured to define a working portion and is placed between the front end and the second opening.

The first connection port, one portion of the mounting space, and the first passage in combination are configured to establish a first path. The second connection port, the other portion of the mounting space, and the second passage in combination are configured to establish a second path separated from the first path. The working portion is configured to be positioned only in the hypopharynx, and the working portion is ranged from 0.1 cm to 3 cm in the elongated direction.

In detail, the terms “single tube body” refer to a tubular structure that internally contains multiple passages, while externally presenting as a single tube. In other words, the extension (or passage) does not have any branches in directions other than the elongation direction, the whole extension may be inserted into the human body along an elongated direction of one lumen. Under a similar concept, the extension may be formed by connecting the outer surfaces of two tubes together. Alternatively, the extension may be formed by one tube sleeved on another tube, creating multiple passages within the extension.

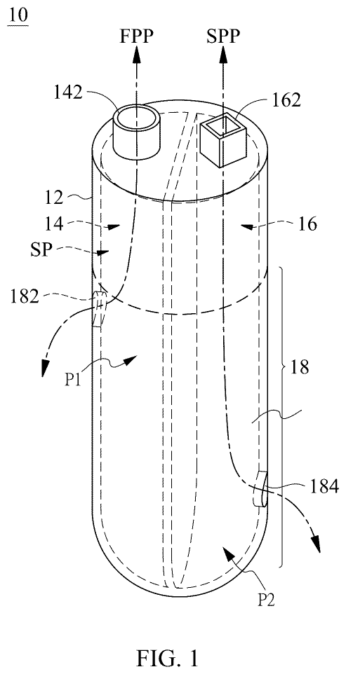

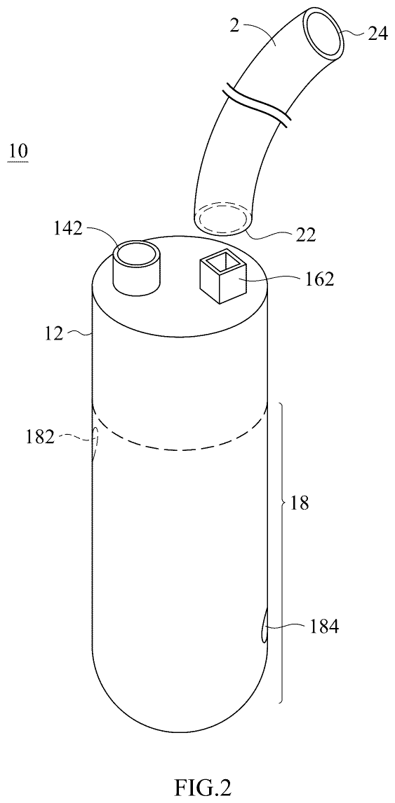

Please refer to FIG. 1, where it is a structure diagram of a first embodiment of a nasogastric tube of the present disclosure. In FIG. 1, the nasogastric tube 10 may be connected to one or a plurality of outer tubes 2 (with reference to FIG. 2) by the adapter for application to stomach and throat in human body. An end 22 of the outer tube 2 is connected to the nasogastric tube 10 while the other end 24 may be selectively connected to another external equipment such as a gas cylinder, an external breathing equipment, a negative pressure equipment, a spray equipment, or drug delivery device or equipment, etc. Notably, the outer tube 2 may be freely assembled and disassembled, or be omitted. For example, if the nasogastric tube 10 needs to obtain oxygen from a gas cylinder, the nasogastric tube 10 and the gas cylinder may be connected through the outer tube 2 for supply of oxygen; if the function of the nasogastric tube 10 is to provide nebulized medicine, the medicine may be directly received without the use of the outer tube 2.

Back to FIG. 1, the adapter of the nasogastric tube 10 includes a housing 12. The housing 12 forms a mounting space SP which includes a first chamber 14 and a second chamber 16. Herein, the shape of the housing 12 is tubular for illustration purpose, nevertheless, the housing 12 may be of any shape, size, material, etc. without any constraint in the present disclosure. The number of chambers is two for illustration purpose. For illustration, the first chamber 14 is designated for draining secretions, delivering gas or powder while the second chamber 16 is designated for delivering liquid, nutrition, or draining gastric contents.

Furthermore, the first chamber 14 and the second chamber 16 are not connected to each other, herein the formation method of the first chamber 14 and the second chamber 16 is not limited, for example, the formation method may be all-in-one or adding a partition board (not shown) in the mounting space (SP) to segment the first chamber 14 and the second chamber 16. In one embodiment, the dimensions of the first chamber 14 are smaller than or equal to those of the second chamber 16, or the dimensions of the second chamber 16 are smaller than or equal to those of the first chamber 14.

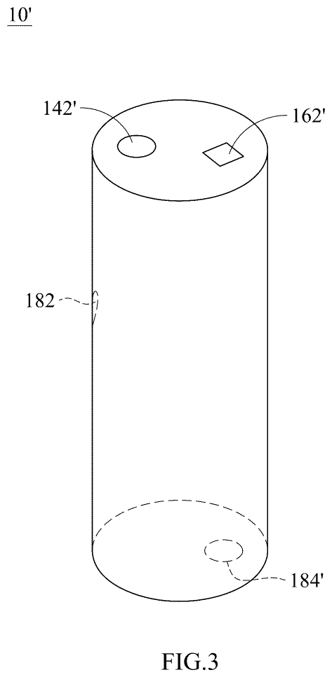

The first chamber 14 has a first connection port 142, the second chamber 16 has a second connection port 162. Herein, as an example for illustration, the first connection port 142 is of cylindrical shape whereas the second connection port 162 is of rhombic shape, but other embodiments are not limited to the aforesaid shapes. The first connection port 142 and the second connection port 162 may be arranged to have different shapes to achieve the foolproof (or called anti-misplacement) purpose. Moreover, the first connection port 142 and the second connection port 162 have a protruding shape, while in another embodiment, with reference to FIG. 3 of a second embodiment of a nasogastric tube 10′ wherein the first connection port 142′ and the second connection port 162′ thereof are flat openings.

Back to FIG. 1, the first chamber 14 and the second chamber are connected to a front end of an extension 18 having a first opening 182 and a second opening 184 in an elongated direction, wherein the diameter of the first opening 182 is smaller than or equal to the diameter of the second opening 184; alternatively, the diameter of the second opening 184 is smaller than or equal to the diameter of the first opening 182.

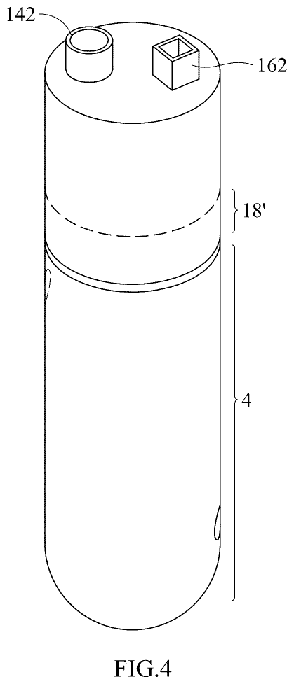

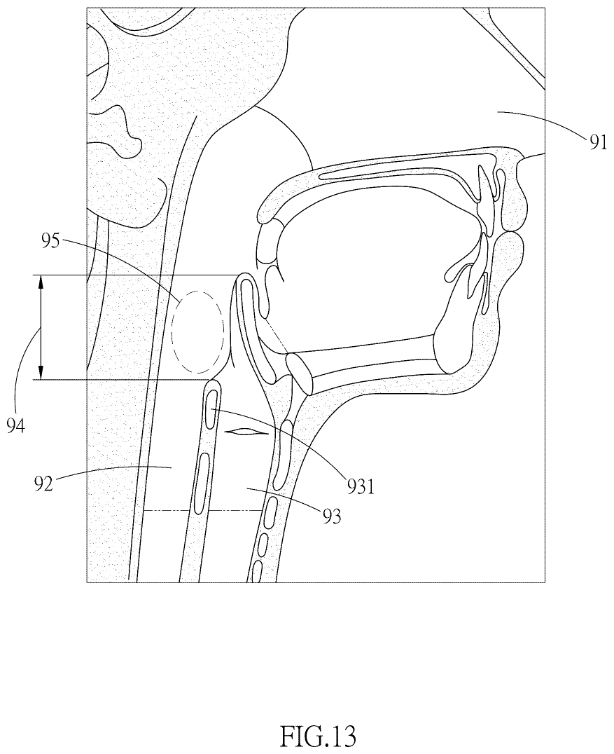

Referring to FIG. 13 as well, here, the first chamber 14 is connected to the first opening 182 and the second chamber 16 is connected to the second opening 184. Furthermore, the first opening 182 may be correspond to and be applied to the hypopharynx 94 and the second opening 184 may be correspond to and be applied to the stomach 96. In this embodiment, the extension 18 may directly act as an inner tube. Alternatively, shown in FIG. 4, the extension 18′ further connects to another external inner tube 4 being provided with the first opening 182 and the second opening 184, so that first opening 182 and the second opening 184 may be placed respectively nearby predetermined lumen or inside the tubular organ. Note that the interior of the external inner tube 4 needs to form corresponding space in accordance with the number of openings, that is, the interior of the external inner tube 4 has the extending characteristic of the chamber, and the spaces inside of the external inner tube 4 also have the characteristic of the corresponding chambers in that they are not connected with one another. In the other words, both of extension 18 and the external inner tube 4 are provided with two separated passages, the first passage P1 connect to the first chamber 14 of the housing 12, the second passage P2 connect to the second chamber 16 of the housing 12.

Referring back to FIG. 3, the location of the first opening 182 and the second opening 184 are not limited in the present disclosure; the first opening 182 and the second opening 184 may be provided on the sides of the extension 18 as in FIG. 1, while the second opening 184′ may also be provided at the bottom of the extension 18 as in FIG. 3. In addition, the length and shape of the extension 18 are also not limited. In FIG. 4, as the extension 18′ is able to connect to the external inner tube 4, extension 18′ does not need to be too long. Hence, the length of the extension 18 in FIG. 1 is conspicuously larger than the length of the extension 18′ in FIG. 4.

Back to FIG. 1, the first opening 182 is fluidly connected to the first chamber 14, the second opening 184 is fluidly connected to the second chamber 16. The first connection port 142 fluidly connects to the first chamber 14 and the first opening 182, enabling the external equipment to establish a first supply path FPP through the first connection port 142, the first chamber 14 and the first opening 182. The first supply path FPP may be applied to the hypopharynx 94 via the first opening 182. Similarly, the second connection port 162 is fluidly connected to the second chamber 16 and the second opening 184, enabling the external equipment to establish a second supply path SPP through the second connection port 162, the second chamber 16 and the second opening 184. The second supply path SPP may be applied to stomach 96 via the second opening 184.

According to different application scenarios, the first supply path FPP and the second supply path SPP have primarily several configurations, for example: a first configuration in which the first supply path serves to draw secretions such as sputum, saliva, secretions through negative pressure in order to prevent liquid from entering the lungs; a second configuration in which the first supply path FPP serves to draw in external medicine powder, medicine spray, oxygen or water vapor spray and supply same to the throat for treatment; a third configuration in which the second supply path acts similarly to a nasogastric tube to provide feeding from outside or drainage; a fourth configuration in which the third configuration, if in use, is employed simultaneously with the first configuration or the second configuration. Besides the aforementioned four configurations, other unmentioned configurations are further included.

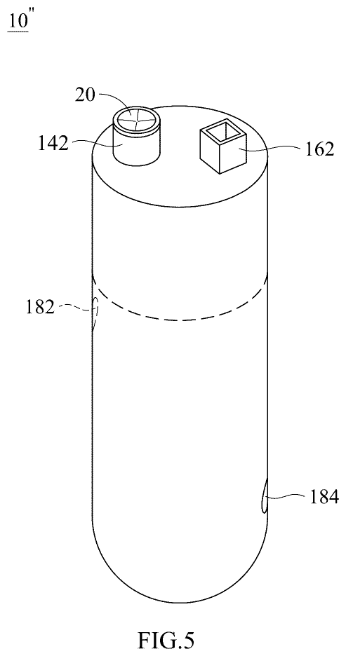

Please refer to FIG. 5, a structure diagram of a fourth embodiment of the nasogastric tube of the present disclosure. In FIG. 5, the nasogastric tube 10″ further includes an elastic blocking piece 20 in addition to the housing 12 of the first embodiment.

The elastic blocking piece 20 is disposed on the opening of the first connection port 142, used to selectively connect the first supply path FPP with the external equipment connected to the first connection port 142. The state of the elastic blocking piece 20 determines whether the first supply path FPP between the external equipment and the respiratory system is open or not.

In some embodiments, the elastic blocking piece 20 includes multiple baffles (valves) with a predetermined thickness. A portion of the baffles is disposed on the side wall of the opening of the first connection port 142. The edge profiles of the multiple baffles are adjacent and shape-matching. When an external force is applied to the baffles, the baffles of the elastic blocking piece 20 deform, exposing the edge surfaces of the multiple baffles, forming an opening in the elastic blocking piece 20. When the baffles are not subjected to external force, the adjacent edges of the multiple baffles fit tightly, closing the opening formed between the baffles and sealing the opening of the first connection port 142.

In some embodiments, the elastic blocking piece 20 may include a baffle (not shown) and an elastomer (not shown). The baffle is coupled with the elastomer. One end of the baffle is disposed on the side wall of the opening of the first connection port 142. The other end of the baffle is placed against the opposite side wall of the first connection port 142 through the elastomer. When an external force is applied to the baffle, the elastomer will deform accordingly, exposing the opening of the first connection port 142, thereby allowing the external equipment to connect to the first chamber 14 through the first connection port 142.

Moreover, taking one of the supply paths (the first supply path FPP) as an example, the elastic blocking piece 20 is constructed as a passive opening structure to provide the following patterns: (1) in the absence of any applied force, the elastic blocking piece 20 closes the first supply path FPP; and (2) when subjected to, for example, the insertion of an outer tube, the opening of the elastic blocking piece 20 is opened, establishing the first supply path FPP.

However, the opening of the second connection port 162 may also be provided with the elastic blocking piece 20 in a similar manner so as to perform similar functions.

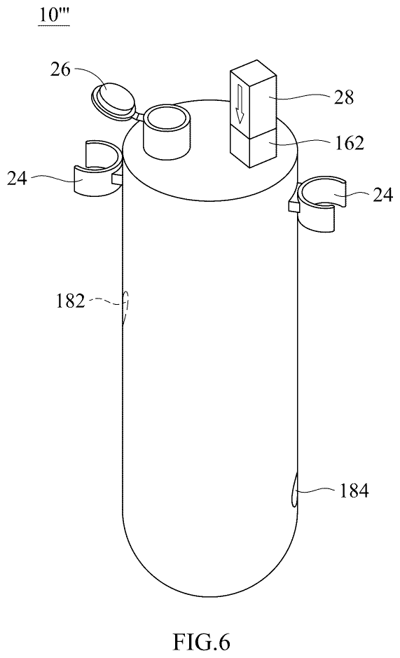

Please refer to FIG. 6, a structure diagram of a fifth embodiment of the nasogastric tube of the present disclosure. In FIG. 6, the nasogastric tube 10′″ further includes a fastener 24, a closing component 26 and an indicator 28 in addition to the housing 12 of the first embodiment.

The fastener 24 is disposed on the housing 12 for fixing the housing 12 onto a human body, clothing or for the purpose of fixing an outer tube, wherein the fastener 24, for example, may be configured to be a buckle or a c-ring. In the configuration of fixing onto the human body, the nasogastric tube 10″ may be fixed to the head via a strap in combination with a buckle; and, in some embodiments, in the fixing the outer tube configuration, the outer tube may be snapped on via the c-ring.

The closing component 26 is couple with the connection port 142 in order to selectively close the opening of the first port 142 and the corresponding first supply path FPP. For example, the close component 26 may be a cover, such as a cap or a stopper, the close component 26 may be a valve or clamps. Additionally, the opening of the second port 162 may be closed by means of the closing component 26 in a similar manner. Here, the cap shall be taken as an example to illustrate the closing component 26.

The indicator 28 is disposed on the opening of the first connection port 142 (or the second connection port 162), capable of indicating the supply direction of, for example, the first supply path FPP and the second supply path SPP, and the form thereof may be a sleeve.

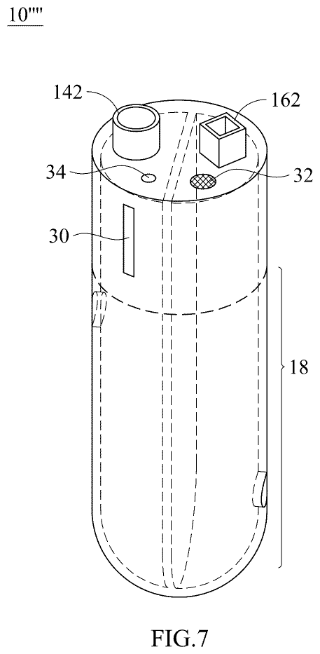

Please refer to FIG. 7, a structure diagram of a sixth embodiment of the nasogastric tube of the present disclosure. In FIG. 7, the nasogastric tube 10″″ further includes a physiological monitoring module 30, an environment monitoring module 32 and a signal outputting module 34 in addition to the housing 12 of the first embodiment.

The physiological monitoring module 30 is used to detect physiological data at its monitoring location. It may be placed at any position along the first supply path FPP or second supply path SPP formed by the nasogastric tube, such as at the housing 12, the opening of the first connection port 142, the opening of the second connection port 162, inside the first chamber 14 or inside the second chamber 16. The physiological monitoring module 30 also may be disposed on the extension 18, near the first opening 182 or the second opening 184. The physiological monitoring module 30 may be used to detect the monitoring conditions such as the patient's call, internal body sounds, physiological temperature, oxygen concentration, carbon dioxide concentration, pH value, or displacement acceleration when the patient moves. The physiological monitoring module 30 may also be used to sense the fluid velocity and flow rate inside the first supply path and second supply path. These sensed signals can be processed through, for example, an application (APP) to obtain information such as airflow status, feeding frequency, feeding time, and patient consciousness.

The environmental monitoring module 32 can be disposed on the housing 12 to detect the conditions of the patient's surrounding space. The environmental monitoring module 32 can be, for example, a photosensitive element, microphone element, image capturing element, thermometer, or hygrometer, used to detect the environmental conditions such as the environmental lights (brightness of the ward), external sounds, external images, surrounding temperature, or humidity.

The signal outputting module 34 is disposed on the housing 12 and may be, for example, an LED element, electrothermal coupling element, speaker, battery, or motor, correspondingly used to emit light, output thermal energy, make sounds, generate micro-currents, or generate vibrations. The signal outputting module 34 may communicate with the physiological monitoring module 30 or the environmental monitoring module 32. The signal outputting module 34 generates output signals corresponding to the monitoring signals form the aforementioned monitoring modules, to indicate the patient's condition. Furthermore, the signal outputting module 34 may communicate wirelessly with the physiological monitoring module 30 or the environmental monitoring module 32, allowing the signal outputting module 34 to be placed separately from the housing 12.

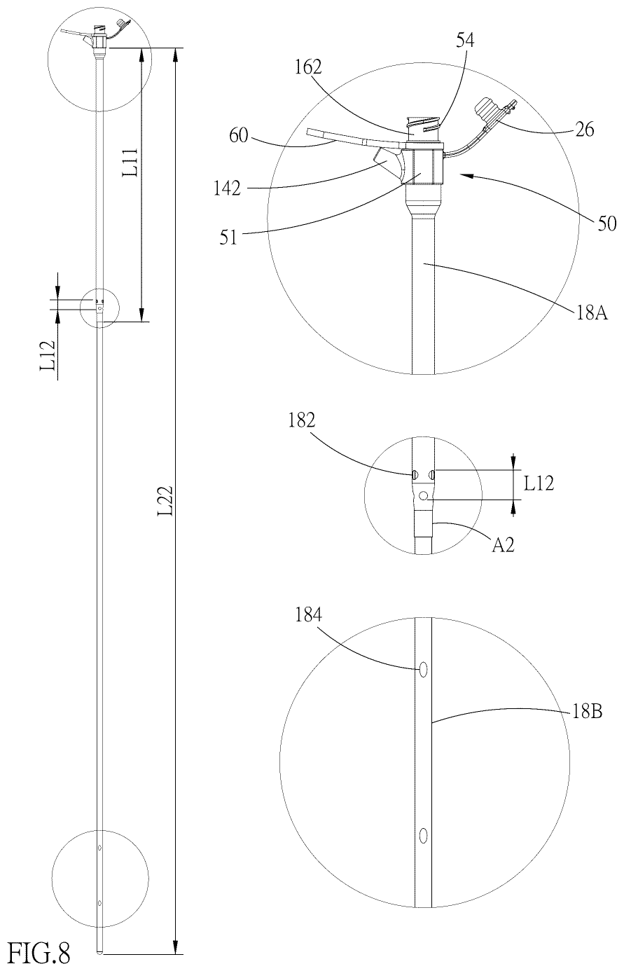

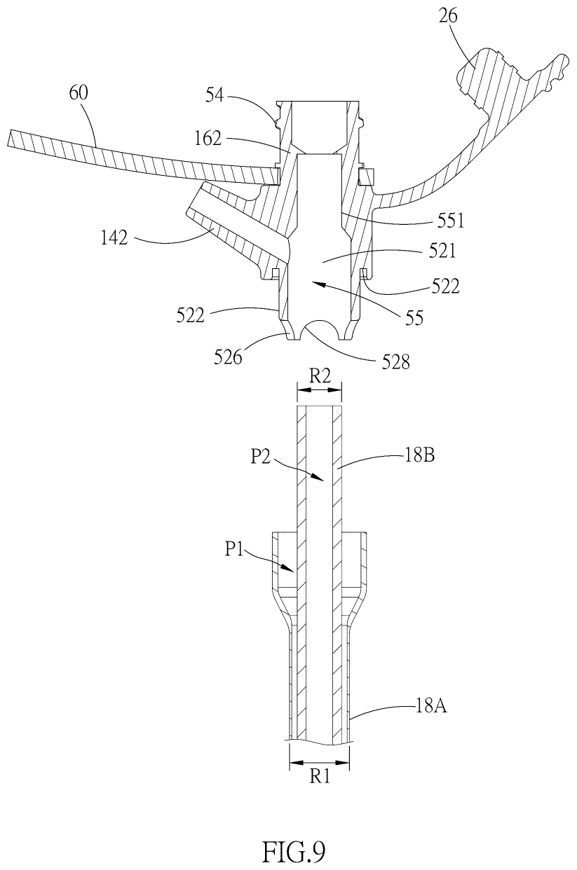

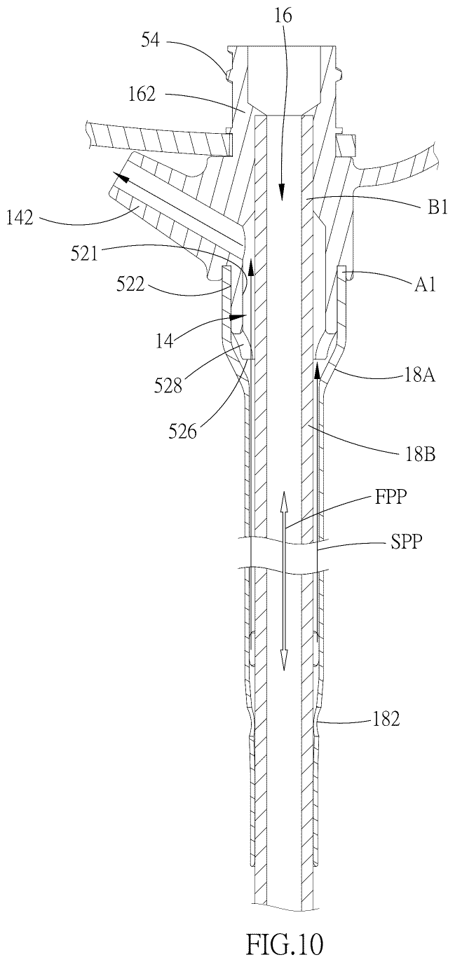

Please refer to FIG. 8 to FIG. 10, which illustrate the seventh embodiment of the nasogastric tube. A nasogastric tube with multiple passages, including an adapter, a first tube 18A, and a second tube 18B. Except for the connection structure with the adapter, the main parts of the first tube 18A and the second tube 18B are belong to inner tubes as described in previous embodiments, and are configured mainly to be placed inside the human body.

The adapter in this embodiment comprises housing 50, the shape of a main body 51 of the housing 50 is tubular and is used to define a mounting space 55, the housing 50 is also provided with a first connection port 142, and a second connection port 162. The mounting space 55 is fluidly connected to the first connection port 142 and the second connection port 162 respectively.

The first tube 18A has a front end A1 disposed on the housing 50, the rear end A2 of the first tube 18A is provided with a first opening 182. The second tube 18B has a front end B1 disposed on the housing 50, the rear end B2 of the second tube 18B is provided with a second opening 184. The front end A1 of the first tube 18A and the front end B1 of the second tube 18B are close to the housing 50 relative to their rear ends A2, B2. The first opening 182 at the rear end A2 of the first tube 18A corresponds to the first opening 182 of the nasogastric tube 10 that is applied to the pharynx and/or larynx in previous embodiments present in FIG. 1. The second opening 184 at the rear end B2 of the second tube 18B corresponds to the second opening 184 of the nasogastric tube 10 that is applied the stomach in previous embodiments present in FIG. 1.

In this embodiment, the housing 50 has a ring-shaped partition structure 52 forming the mounting space 55. A portion of the mounting space 55 forms a radially contracted neck slot 551, with the extension direction of the neck slot 551 being the same as that of the front end B1 of the second tube 18B. The ring-shaped partition structure 52 laterally forms the first connection port 142 at locations other than the neck slot 551, the first connection port 142 is fluidly connected to the mounting space 55. The opening at the front end B1 of the second tube 18B connected to the neck slot 551 also fluidly connects to the second connection port 162 through the neck slot 551. A portion of the outer surface of the second tube 18B is located inside the mounting space 55 and is spaced apart from the inner annular wall 521 of the ring-shaped partition structure 52. The main body 51 of the housing 50 has a slot 552 surrounding the ring-shaped partition structure 52. The opening at the front end A1 of the first tube 18A connects to the slot 552, allowing the first tube 18A to be sleeved on the outside of the second tube 18B, appearing as a single tube structure externally. After the first tube 18A and the second tube 18B are assembled, the first opening 182 of the first tube 18A is located between the second opening 184 of the second tube 18B and the housing 50.

Therefore, the first connection port 142, a portion of the mounting space 55 separated from the second tube 18B (corresponding to the first chamber 14 aforementioned), and an inner space of the first tube 18A in combination are configured to establish a first path, which corresponds to the first supply path FPP in previous embodiments. The second connection port 162, the space in the mounting space 55 where the second tube 18B is occupied (corresponding to the second chamber 16 aforementioned), and an inner space of the second tube 18B in combination are configured to establish a second path, which corresponds to the second supply path SPP in previous embodiments, the inner space of the second tube 18B is corresponded to the second passage P2 of the extension 18 (shown as FIG. 1). The second tube 18B inside the mounting space 55 separates the first chamber 14 being configured to form the first path and the second chamber 16 being configured to form the second path. The space between an inner surface of the first tube 18A and an outside surface of the second tube 18B is corresponded to the first passage P1 of the extension 18 (shown as FIG. 1). The inner surface of the first tube, the surface (inner annular wall 521) of the ring-shaped partition structure 52 and the outside surface of the second tube 18B in combination define the boundary of the first path, ensuring that the first chamber 14 and the second chamber 16 are not connected to each other.

In this embodiment, the ring-shaped partition structure 52 is constructed to be located on the main body 21 and away from the second connection port 162. When the opening of the front end A1 of the first tube 18A connects to the slot 552, a portion of the inner surface of the first tube 18A is also sleeved on an outer annular wall 522 of the ring-shaped partition structure 52. The ring-shaped partition structure 52 has multiple protrusions 526 extending towards the elongated direction of the first tube 18A. In other words, these multiple protrusions 526 are located on the inside of the first tube 18A but surround the outside of the second tube 18B.

In this embodiment, the contours between the multiple protrusions 526 form multiple concave contours 528 at the end of the ring-shaped partition structure 52. In some embodiments, the multiple protrusions 526 are equiangularly arranged on the ring-shaped partition structure 52 along a circumferential direction. In some embodiments, the ring-shaped partition structure 52 as whole forms a crown shape. However, the end face of the ring-shaped partition structure 52 may also be designed in a wave shape to provide with similar function.

The first path in this embodiment is located between the inner surface of the first tube 18A and the outside surface of the second tube 18B, forming a path with a ring cross-section. However, if the end surface of the separation structure between the first tube 18A and the second tube 18B has no undulating structure in the elongated direction, that is, the structure of the end surface is the same in all (circumferential) directions, when the first connection port 142 with thin tubular wall is connected to negative pressure equipment, the tubular wall of the first tube 18A might randomly deform radially and inwardly along the ring-shaped end face of the internal rigid component via the negative pressure. The passage inside the first tube 18A may randomly collapse and be block, and it may not ensure smooth suction.

In this embodiment, the end of the ring-shaped partition structure 52 has multiple protrusions 526 extending towards the elongated direction of the first tube 18A. When the first connection port 142 is connected to a negative pressure equipment through the outer tube 2, the tubular wall of the first tube 18A will collapse along the end faces of two adjacent protrusions 526 where are formed the concave contours 528 during suction. In other words, the deformed position of the tubular wall of the first tube 18A is determined by the position of the concave contours 528. This embodiment not only ensures that the chamber (first chamber 14) defined by the inside of the protrusions 526 remains unobstructed, but also disperses the deformed positions of the tubular wall of the first tube 18A by the concave contours 528, the passage formed by the tubular wall first tube 18A may be retained when portion of the tubular wall of the first tube 18A is deformation, ensuring that the internal passage of the first tube 18A may maintain a specific shape and remain unobstructed.

The ring-shaped partition structure 52 enables the first tube 18A to be made of membrane material, reducing the outer diameter of the nasogastric tube. Besides, since the end structure of the ring-shaped partition structure 52 has been constructed to disperse the collapse degree of the tubular wall of the first tube 18A, in this case, reducing the volume of the first chamber 14 does not affect the suction performance.

In this embodiment, the functions of the first connection port 142 and the second connection port 162 may be compared to previous embodiments. They are constructed to independently connect to external equipment, correspondingly providing input of gas or substance towards the first path or the second path or providing output of gas or substance inside the first path or the second path. As previously aforementioned, the first path corresponds to the first supply channel FPP in previous embodiments, with the first opening 182 of the first path opening into the lumen, allowing the first supply channel FPP that is applied to the pharynx and/or larynx. The second path corresponds to the second supply channel SPP in previous embodiments, with the second opening 184 of the second path opening into the organ of the human body, allowing the second supply channel SPP that is applied to the stomach.

The first connection port 142 and/or the second connection port 162 is provided with an opening closure unit used to correspondingly close the opening of the first connection port 142 and the second connection port 162 that connect to external equipment. The structure of the opening closure unit may refer to the elastic blocking piece 20 or closing component 26 previously aforementioned, but is not limited to. For example, if the indicator 28 may be used to close the opening of the first connection port 142 or the second connection port 162 connecting to external equipment, it may also serve as the aforementioned opening closure unit.

The first connection port 142 and the second connection port 162 may have different shapes, contours, or colors in appearance to identify that the ports provide different functions. In this embodiment, the extension directions of the first connection port 142 and the second connection port 162 are different.

The nasogastric tube of this embodiment is constructed as one component of a two-piece nasogastric tube. The second connection port 162 is tubular with external threads 54 for connecting to an end of a feeding tube. The closing component 26 connects to the main body 51 at one end and has a cap at the other end. The cap of closing component 26 is constructed to seal the opening of the second connection port 162 when feeding or stomach content suctioning is not required.

In this embodiment, the main body 51 is also provided with a holding member 60. The holding member extends radially from the main body and may provide an additional gripping point for caregivers when handling the housing 50.

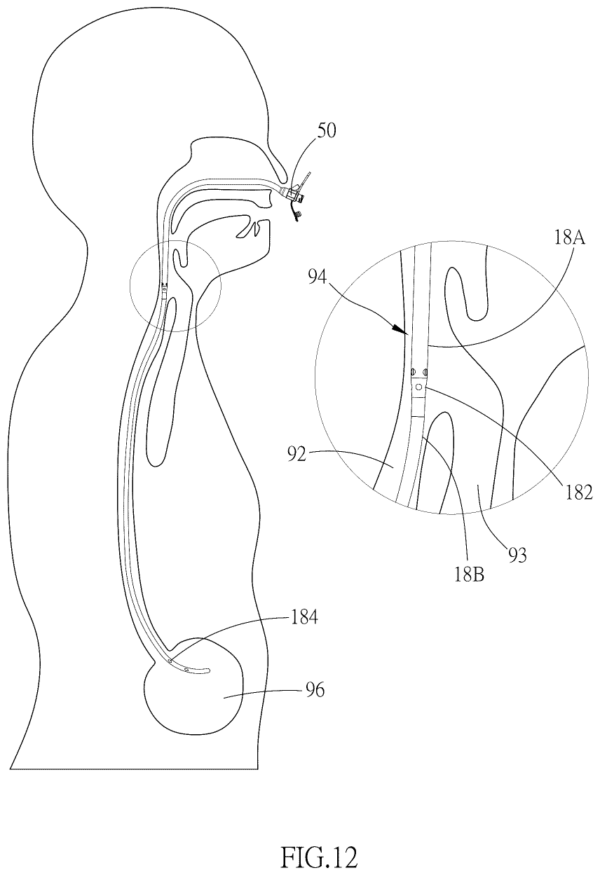

Please refer to FIG. 12, which illustrates the situation of the seventh embodiment of the nasogastric tube placed inside the human body. Assuming that the front end A1 of the first tube 18A and the front end B1 of the second tube 18B are located at approximately the same position, the length L11 from the front end A1 of the first tube 18A to the first opening 182 is ranged from 10 cm to 23 cm, while the length L22 from the front end B1 of the second tube 18B to the second opening 184 is ranged from 40 cm to 75 cm. For application in adults, L11 is approximately ranged from 15 cm to 20 cm, and L22 is approximately ranged from 50 cm to 70 cm, with smaller dimensions for children.

The tube outer diameter R2 of the second tube 18B is ranged from 2 mm to 6 mm. The range for adults is 4 mm to 6 mm, and for children is 2 mm to 3.3 mm. The outer diameter R1 of the first tube 18A is slightly larger than the tube diameter R2, varying with R2, so the outer diameter R1 of the first tube 18A may be ranged from 3 mm to 8 mm. In other words, the outer diameter R1 may be 3 mm, 3.5 mm, 4 mm, 4.5 mm, 5 mm, 5.5 mm, 6 mm, 6.5 mm, 7 mm, 7.5 mm or 8 mm.

Corresponding to the general use of nasogastric tubes, the rear end B2 of the second tube 18B is inserted through the nasal cavity, passing along the pharynx into the esophagus, allowing the second opening 184 of the second tube 18B to enter the gastric cavity, and positioning the first opening 182 of the first tube 18A in the hypopharynx, with the housing 50 remaining outside the nasal cavity. The first opening 182 is generally located between the epiglottis and the opening of the esophagus. The first opening 182 may be constructed to direct toward the larynx, but the first tube 18A does not enter the larynx (trachea). Alternatively, the first opening 182 may be constructed to be directed toward the posterior wall of the hypopharynx, specifically towards the pyriform sinuses and/or surrounding the hypopharynx located on both sides of the esophageal entrance, in order to suction secretions that accumulate in the hypopharynx when the patient is lying down, or the first opening 182 may be constructed to direct toward the opening of the trachea, used to suction secretions that might enter the trachea. In the case where there is multiple first openings 182 circumferentially surrounding the first tube 18A, the multiple first openings 182 may correspond to multiple positions in the pharynx.

Please also refer to FIG. 13. Secretions 95 in the path of the hypopharynx 94 may be removed by suction through the first opening 182, it can prevent patients from choking or aspiration. The first path in this embodiment may be applied to suction secretions (for example: saliva, secretions produced by tube stimulation of the mucosa), eliminating the need to insert an additional suction tube through the oral cavity and reducing patient discomfort.

In some embodiments, if the distribution of the first opening 182 along the elongated direction of the first tube 18A is defined as a working section, and multiple first openings are at the same distance from the front end A1 and surround the first tube 18A, the working section may be formed as a ring-shaped working section. In this example, the working section defined based on multiple first openings and a working section defined based on an aperture size of one first opening have the same the extension distance L12 in the elongated direction, the extension distance L12 of the working section is about 0.1 cm.

In some embodiments, the distances of multiple first openings 182 from the front end A1 of the first tube 18A may be different, but the positions of the first openings 182 are generally placed at the hypopharynx, used to suction secretions at different segments along the extended path. In this example, the working section is constructed in a distance not exceeding 3 cm in the elongated direction, providing better suction efficiency.

In other words, along the elongated direction of the first tube 18A, the extension distance L12 of the working section is ranged from 0.1 cm to 3 cm.

In detail, patients who cannot swallow saliva into the esophagus will accumulate it in the pyriform sinuses on both sides of the esophageal entrance. Therefore, the first opening 182 of the working section may be constructed to be positioned only in the hypopharynx and be directed towards the pyriform sinus, which has a depth of approximately 1 cm to 2 cm. In this embodiment, the length of the working section along the elongated direction may be reduced and range from 1 cm to 1.5 cm. An accurate working section can concentrate the suction action in a specific area, resulting in a more effective suction effect. In other words, the working section L12 may be 0.1 cm, 0.3 cm, 0.5 cm, 0.7 cm, 0.8 cm, 1.1 cm, 1.3 cm, 1.6 cm, 1.8 cm, 2 cm, 2.3 cm, 2.5 cm, 2.8 cm or 3 cm.

In some embodiments, the multiple protrusions 526 are arranged on the ring-shaped partition structure 52 along a circumferential direction with unequal angles. Alternatively, the number of the protrusion 526 on the ring-shaped partition structure 52 is single and is arranged between the first second tube and the second tube. Compared with other portion of end contours of the annular partition structure 52, the contour of the protrusion 526 forms a relatively protruding end face. The deformation position of the tubular wall of the first tube 18A depends on the position of the protruding end face, and a similar effect can also be achieved.

The aforementioned suction means (removal of secretions) and working section are described based on the first tube 18A connecting to an external negative pressure equipment through the first connection port 142, but the first tube 18A may also connect to a positive pressure equipment (such as a gas supply equipment, spray supply equipment) or a supply equipment (such as a medication delivery device or equipment) through the first connection port 142. Similarly, the second tube 18B may connect to an external negative pressure equipment, positive pressure equipment, or supply equipment through the second connection port 162.

In some embodiments, similar to previous embodiments, a monitoring module may be placed at any position along the first path or second path formed as described above. For example, it may be located in the main body 51 of the housing 50, the opening of the first connection port 162, the opening of the second connection port 142, inside the mounting space 55, or the monitoring module may be placed in the first tube 18A or second tube 18B, and may be near the first opening 182 or second opening 184. The monitoring module may be similar to the previously mentioned physiological monitoring module 30 or environment monitoring module 32, and the monitoring module may also communicate with the signal outputting module 34.

The present disclosure is disclosed in the abovementioned description by several preferred embodiments, but it is supposed to be comprehended by those who are skilled in the art that the embodiments are used only to illustrate the present disclosure rather than restrict the scope of the present disclosure. It should be noted that any equivalent variance or replacement in the embodiments shall be covered by the scope of the present disclosure. Therefore, what is claimed in the present disclosure shall be subject to the claims.

What is claimed is:

1. A nasogastric tube with multiple passages, comprising:
an adapter comprising a housing defining a mounting space, a first connection port and a second connection port, the mounting space fluidly connected to the first connection port and the second connection port respectively;
an extension being constructed as a single tube body with a front end being disposed on the housing, the extension having a first passage and a second passage that are separated from each other;
wherein, the extension has a first opening connected to the first passage and has a second opening connected to the second passage, the extension is extended alone an elongated direction, a portion of the extension where the first opening exists is configured to define a working portion and is placed between the front end and the second opening;
wherein, the first connection port, one portion of the mounting space, and the first passage in combination are configured to establish a first path;
wherein, the second connection port, the other portion of the mounting space, and the second passage in combination are configured to establish a second path separated from the first path;
wherein, the working portion is configured to be positioned only in the hypopharynx, and the working portion is ranged from 0.1 cm to 3 cm in the elongated direction.

2. The nasogastric tube according to claim 1, wherein a length between the front end and the first opening is ranged from 10 cm to 23 cm in the elongated direction.

3. The nasogastric tube according to claim 1, wherein the number of the first opening is plural, the working portion is ranged from 1 cm to 1.5 cm in the elongated direction.

4. The nasogastric tube according to claim 1, wherein the number of the first opening is plural, the plurality of first openings are at different distances from the front end of the extension.

5. The nasogastric tube according to claim 1, wherein the first opening is configured to be positioned only in the hypopharynx and toward the pyriform sinus.

6. The nasogastric tube according to claim 1, wherein the first connection port or the second connection port is configured to connect to an external equipment, the external equipment is configured to input gas or substance into the extension, or to output gas or substance from inside the extension.

7. The nasogastric tube according to claim 1, wherein extension directions of the first connection port and the second connection port are different.

8. The nasogastric tube according to claim 1, wherein the first connection port and the second connection port have different shapes, contours, or colors.

9. The nasogastric tube according to claim 1, wherein the outer diameter of the extension is ranged from 3 mm to 8 mm.

10. The nasogastric tube according to claim 1, further comprising a monitoring module being arranged around the first path or the second path formed by the nasogastric tube, the monitoring module comprises a physiological monitoring module and/or environment monitoring module.

11. The nasogastric tube according to claim 10, wherein the physiological monitoring module is configured to detect a condition of fluid velocity, flow rate, sound, temperature, oxygen concentration, carbon dioxide concentration, pH value, and/or displacement acceleration.

12. The nasogastric tube according to claim 10, wherein the environment monitoring module is configured to detect a condition of light source, sound, image, temperature and/or humidity.

13. The nasogastric tube according to claim 1, wherein the adapter comprises a holding member.

14. The nasogastric tube according to claim 1, wherein the extension comprises a first tube being provided with the first opening and a second tube being provided with the second opening, the first tube being sleeved on an outside of the second tube, the first path is defined between the outside of the second tube and an inside of the first tube.

15. The nasogastric tube according to claim 14, wherein the housing includes a ring-shaped partition structure with a plurality of protrusions extending along the elongated direction, the plurality of protrusions is arranged to surround the outside of the second tube.

16. The nasogastric tube according to claim 15, wherein the plurality of protrusions are equiangularly arranged on the ring-shaped partition structure.

17. The nasogastric tube according to claim 14, wherein the outer diameter of the first tube is ranged from 3 mm to 8 mm.

18. The nasogastric tube according to claim 14, wherein the number of the first opening is plural, the plurality of the first opening are surrounding a tube body of the first tube.

19. The nasogastric tube according to claim 14, wherein the housing includes a ring-shaped partition structure with a protrusion extending along the elongated direction, the protrusion is arranged between the first second tube and the second tube.
